(19) United States
(12) Patent Application Publication
(10) Pub. No.: US 2021/0218616 A1
(43) Pub. Date: Jul. 15, 2021

(54) SYSTEM FOR HOSTING DATA LINK LAYER AGENT, PROTOCOL, AND MANAGEMENT FUNCTIONS

(71) Applicant: EOS Defense Systems USA, Inc., Huntsville, AL (US)

(72) Inventors: Michael K. Bugenhagen, Santa Clara, CA (US); Sunil Praful Shah, San Jose, CA (US); Ranjit Vadlamudi, San Jose, CA (US); Mark B. Saxelby, Milpitas, CA (US); Abelino C. Valdez, Tracy, CA (US); Bjoern M. G. Hall, Santa Cruz, CA (US)

(21) Appl. No.: 17/212,969

(22) Filed: Mar. 25, 2021

Related U.S. Application Data
(63) Continuation-in-part of application No. 16/802,457, filed on Feb. 26, 2020.
(60) Provisional application No. 62/994,848, filed on Mar. 26, 2020.
(60) Provisional application No. 62/811,500, filed on Feb. 27, 2019.

(51) Int. Cl. H04L 12/24; H04L 12/923; H04L 29/06

(52) U.S. Cl. CPC H04L 41/022; H04L 41/042; H04L 69/22; H04L 47/762; H04L 41/0879

(57) ABSTRACT

Novel tools and techniques in a telecommunication network are provided for implementing a data link layer control plane that may comply with the Ethernet standard and with sub-millisecond transmission control capabilities across multiple dis-similar technologies and bandwidth links. The data link protocol system may be implemented through a cloud system. Setting and resource registries of the nodes in the network may be displayed at a cloud portal for users to adjust the network. The change in the setting may be communicated through an application programming interface of a compute host to change the setting of the network. Each DLP node includes a slow agent and a fast agent. The slow agent is configured to transmit data messages through Ethernet frames. The fast agent is configured to transmit control messages through DLP frames. Each DLP frame includes a header only without a payload and the header carries a control message.

### CROSS-REFERENCE TO RELATED APPLICATION

This application is a continuation-in-part of U.S. patent application Ser. No. 16/802,457, filed on Feb. 26, 2020, which claims priority to Provisional Patent Application Ser. No. 62/811,500, filed on Feb. 27, 2019. This application also claims priority to Provisional Patent Application Ser. No. 62/994,848, filed on Mar. 26, 2020. The subject matter of all of these applications are incorporated herein by reference in their entirety.

### TECHNICAL FIELD

This description relates to control plane agents and protocols in a telecommunication network, such as in the data link layer.

### BACKGROUND

Free Space Optics can transmit at extremely high rates but has a vulnerability to short duration transmission interruption caused by atmospheric impairments or objects interfering with the beam. Conventionally, re-transmission occurs at other layers than the data link layer such as the physical layer or the Internet Protocol layers. High-speed re-transmission occurring at the physical layer is problematic due to vendor chip inter-operability, and the cost of changing optics to upgrade or improve the transmission facilities. Transport layer protocols such as TCP (transmission control protocol) have flow level transmission correction, however, TCP mechanisms are impacted by round-trip delays, and packet loss and use throughput throttling with exponential back-off before restoring throughput to the flow. These methods are both crude and too lengthy to provide transmission control over a wireless or FSO link and are also unsuitable due to the impacts on the service state machines that are reacting in the milliseconds duration. These mechanisms could also create race conditions and low-quality services for any real-time communication across a link subject to packet loss, such as FSO and unregulated wireless spectrum.

With the advent of higher speed Central Processing Units that can run at “line rate” (transmission rates) in the gigahertz speed, Network Processing Units (NPU) and more programable data path functions and applications have emerged and are now capable of replacing dedicated Application Specific Integrated Circuits (ASIC). This new programmable environment allows for functions of the data link layer performing at rates normally only viable at the physical transmission layer.

### SUMMARY

In one embodiment, novel tools and techniques in a telecommunication network are provided for implementing a data link layer control plane that may comply with the Ethernet standard and with sub-millisecond transmission control capabilities across multiple dissimilar technologies and bandwidth links. The data link protocol system may be implemented through a cloud system. Setting and resource registries of the nodes in the network may be displayed at a cloud portal for users to adjust the network. The change in the setting may be communicated through an application programming interface of a compute host to change the setting of the network. Each DLP node includes a slow agent and a fast agent. The slow agent is configured to transmit data messages through Ethernet frames. The fast agent is configured to transmit control messages through DLP frames. Each DLP frame includes a header only without a payload and the header carries a control message.

In yet another embodiment, a non-transitory computer readable medium that is configured to store instructions is described. The instructions, when executed by one or more processors, cause the one or more processors to perform a process that includes steps described in the above computer-implemented methods or described in any embodiments of this disclosure.

In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF DRAWINGS

Embodiments of the disclosure have other advantages and features which will be more readily apparent from the following detailed description and the appended claims, when taken in conjunction with the examples in the accompanying drawings, in which:

FIG. 1A is a block diagram of a system environment of an example telecommunication network, according to an embodiment.

FIG. 1B is a block diagram illustration a reference system architecture of the Cloud/NFV/SDN Systems functional architecture, according to an embodiment.

FIG. 2A is a block diagram illustrating an example framework of network nodes in a telecommunication network, according to an embodiment.

FIG. 2B is a schematic diagram that identifies the “host function” being placed on the network elements in order to provide cloud-like “user-managed access”, and compliance capabilities to the network resources, according to an embodiment.

FIG. 3 is an illustration of a Cloud IAM (Identity and Access Management) system functions, and records to show the system being integrated into for privileges, and cloud compliance, according to an embodiment.

FIG. 4 is a diagram that shows how cloud domains federate resources using IAM systems so that the DLP (data link protocol) resources can be shared between multiple organizations, and users to meet compliance standards, according to an embodiment.

FIG. 5 is a process diagram showing how secure tokens are provided dynamically, and statically to allow users to have access to the IAM system, according to an embodiment.

FIG. 6 shows a reference physical DLP system as a cloud portal or GUI resource as is modeled in a host function, and represented in a host, and at the orchestrator levels, according to an embodiment.

FIG. 7 is a diagram of the logical classes of the DLP resources, according to an embodiment.

FIG. 8 is a depiction of the DLP resource “connections” that are instantiated in the host via connection commands that identify the interfaces on each resource to connect, according to an embodiment.

FIG. 9 depicts where the host functions and host API are implemented on a network node, and an EMS, NMS, another suitable management system to provide the Cloud, compliance, and functionality, according to an embodiment.

FIG. 10 provides an example of the physical, logical, and management system view that host functions use in a registry to provide users with managed access, according to an embodiment.

FIG. 11 provides an example of an orchestration template for configuring resources across multiple hosts, that a DLP provider might provide customers with as part of a service catalog, according to an embodiment.

FIG. 12 provides a graphical view of the physical DLP network model that can be provided by using the host registry of active/inactive resources in a cloud portal, according to an embodiment.

FIG. 13 provides a graphical view of the Logical DLP network link with its traffic control functions which can/may be modified by the user, according to an embodiment.

FIG. 14 provides a flow diagram of the process of a DLP provider establishing a DLP service and then providing a customer the service either via IAM federation or via direct IAM account on the DLP provider IAM domain, according to an embodiment.

FIG. 15 depicts the cloud compliance framework enabled by making the DLP a cloud service resource using an IAM account, with privileges assignable to an audit or compliance engine, according to an embodiment.

FIG. 16 depicts on-system, and off-system applications, and software with a secure connection to the host function, enabling them to interface directly with the DLP agents, and the traffic control functions under that agent, according to an embodiment.

FIG. 17 is a block diagram illustrating DLP lawful intercept architecture, according to an embodiment.

FIG. 18 is a block diagram illustrating components of an example computing machine, according to an embodiment.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Telecom services and resources are conventionally designed with a broad scope that does not enable customers to custom design their network over a provider network because the network provider often offers a managed service approach.

A Data Link Protocol (DLP) may include a data link layer function that provides more advanced functionality than can be used in a provider-managed service schema. The system provides fully manageable resources in Cloud or computing portals and enables agile inter-operability with all the functions within a computing system or architecture that legacy telecom systems and functions do not provide.

Conventional Telecom Management Framework (TMF) architecture focuses on abstracting all services into a BSS (Business Support System), and an OSS (Operational Support System) that requires the provider to complete development cycles for the entire suite of back-office systems before services are released to customers. Cloud computing, however, uses micro-services in a disaggregated control architecture, which is different from how telecom network functions are designed to work. The example systems disclosed herein accomplish agility to avoid a BSS development cycle and provide a standard method for federating or presenting resources with a form of encrypted and secure resource access for the customers of data link layer services, with the supporting information security compliance requirements for confidentiality, integrity, and availability (the CIA triad). The example system embodies a robust and flexible framework.

By way of example, embodiments in general are related to methods, systems, and apparatuses for implementing a set of specialized DLP resources and traffic functions as cloud portal resources for the mapping and management of network traffic across one or more network links and nodes. The system may provide the customer with a user-managed access to the DLP link as its own microservice that can be controlled in cloud portals and aligns with cloud compliance standards to audit access privileges. It should be noted that the term DLP may be used in the application for a specialized DLP that has multiple messaging agents both in the header of the data frames and also using a secondary agent more aligned with traditional packet-based protocol traffic functions that leverage one or more of those agents. DLP may also describe the specific set of resources being exposed and leveraged in the cloud framework.

The implementation method utilizes the cloud infrastructure and virtualization layer host function to convert the DLP functions into cloud resources using a policy and privileges framework provided via a cloud identity and access management (IAM) system. Given the DLP traffic control functions are “hot swappable,” customers can use this network resource as a cloud dynamically changeable service at will.

Various embodiments provide tools and techniques for implementing the DLP monitoring, traffic protection, Quality of Service (QoS) mechanisms, and mapping of traffic across one or more links between nodes, more particularly, to methods, systems, and apparatuses for implementing the Operations, Administration, and Management (OAM) server and protocol functions for the data link layer control to perform the various functions required to classify, map, and un-map traffic into link flows, while providing the ability to add and subtract traffic control functions on-demand or at will.

In various embodiments, a host function is placed on the DLP node, or a DLP protocol agent. In one embodiment, an element management system (EMS) or a network management system (NMS) is placed on a host. Alternatively, or additionally, a host function and application programing interface (API) are placed on a DLP node. EMS or NMS is used to control the DLP resources. The context of the term “host” may be in the computing or cloud domain where an API is exposed on a system for customers to access, which breaks the traditional TMF model of having all services run through the OSS and BSS. The host function enables an agile nature of deploying resources without encountering a full development cycle, that is generally referred to as “DEVOPS,” where a resource can be placed under a customer-facing API as a service. To present a group of DLP nodes as a resource, a host function is placed on the EMS or NMS. Individual DLP agents or DLP enabled nodes can also have host functions and act as a single cloud resource.

In various implementations, the EMS (or NMS) and DLP agents are converted to cloud micro-services using cloud resource patterns, which provide machine readable resource definitions or resource models. A customer's cloud portal can read and automatically display the resource patterns. A customer may understand how to control resources via standard control definitions and audit the resources for compliance using standard tools for utilizing DLP resources.

In various embodiments, a secure API is part of the host function. Standard API protocol such as OAuth provide SSL and SSH using secure token methodologies and provide access security compliance for DLP resources.

In various embodiments the host API function works in conjunction with a centralized IAM using policy.json files (or another form of identity) and accesses privilege records to ensure access compliance and security for DLP resources.

In various embodiments, customers may set up accounts on the DLP provider domain IAM system to receive privileges or the user account on their Enterprise IAM. Other broker form of IAM may be used for single sign-on type resource privilege control for accessing DLP resources.

In various embodiments, customers may be provided with account-based access or tools to the system platform and tools for software compliance for HIPAA, PCI, FEDRAMP. The host function works with an IAM function where auditors are assigned privileges to audit the DLP resource configuration, access privileges, and usage logs.

In various embodiments, the host function also allows IAM type access privileges to on-system (on the DLP node), or off-system based software and applications via the secure API interface, and IAM privilege framework. The feature allows artificial intelligence (AI), machine learning, Internet of Things (IoTs), and other applications to be deployed locally and to directly interface with the DLP agents and the traffic control functions.

In various embodiments, the IAM and host framework allow the DLP resources to be federated or shared with multiple customers via integration with their Enterprise IAM system, or by having accounts directly on the hosting DLP domain IAM.

In various embodiments, the DLP resource function on a host can be split or duplicated between the service levels where the DLP resource function is exposed to the customer as part of platform resources, while keeping operational and lawful intercept functions assignable, but at a level not exposed or visible to the customer via traditional role based access control (RBAC) or account based access control (ABAC).

In one embodiment, a method that creates a host microservice function is described. A cloud host may present resources to users via one or more host functions, resource models, with HTTP secure access, and IAM system interworking to provide support for various features.

In one embodiment, customers may observe and control DLP resources in their own cloud portals.

In one embodiment, DLP resource provides automatic service delivery and resource federation via application of a policy framework such as IAM and host function.

In one embodiment, the DLP system provides cloud compliance capabilities for the customer, and third party audit resource access via the host and IAM policy functions added to a DLP agent, and EMS/NMS.

In one embodiment, the DLP system may provide capacities to add on-system and off-system software access to DLP resources using the host policy and IAM policy framework.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

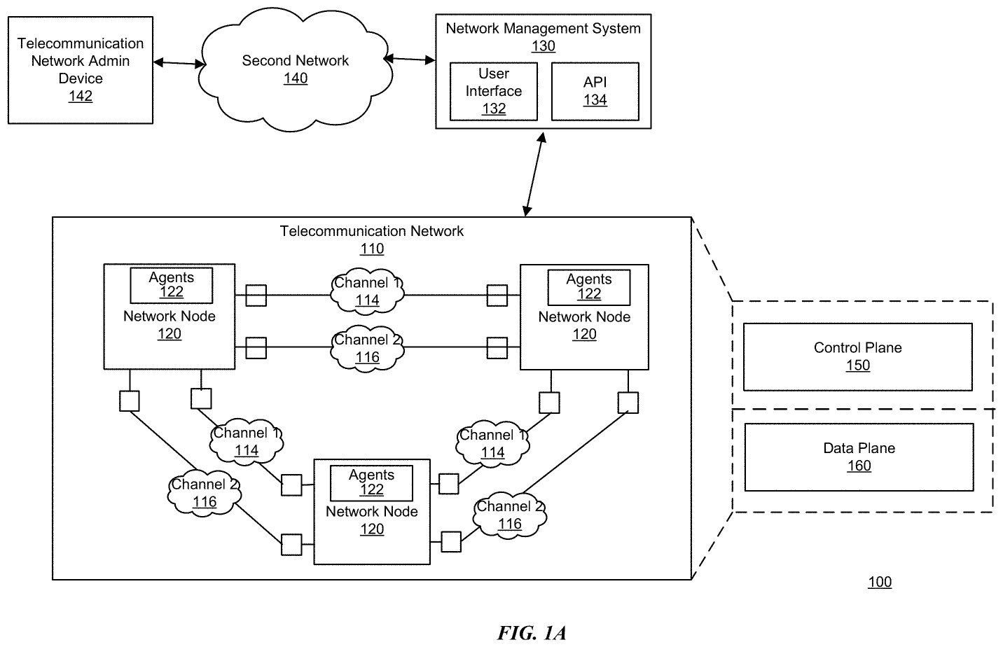

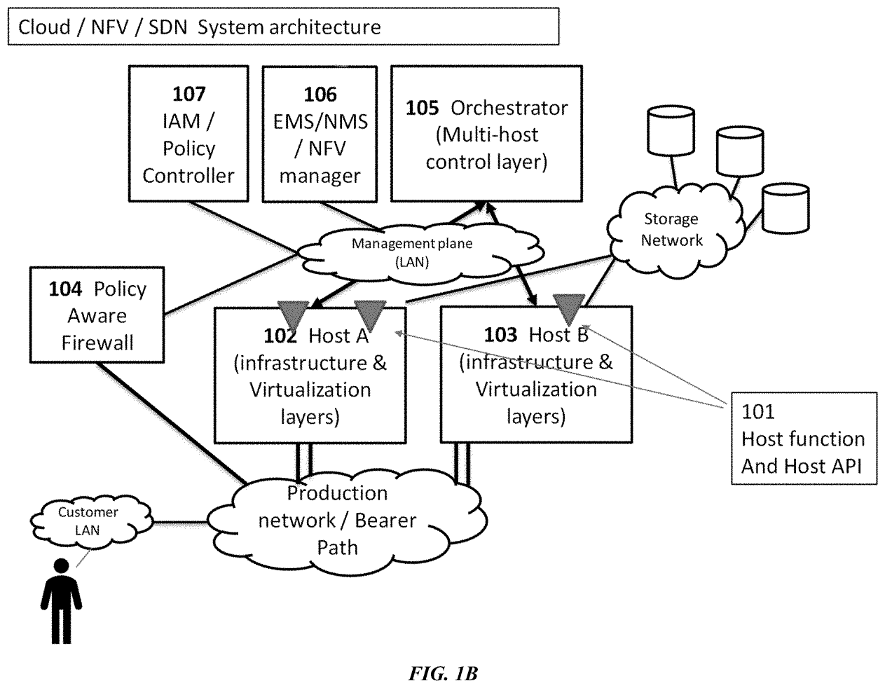

FIG. 1A through FIG. 16 illustrate various features for implementing the DLP as a cloud portal resource with secure connectivity, compliance and audit features, and the capability of federating resources to customers supporting application access into the systems via leveraging an IAM system framework.

FIG. 1A is a block diagram illustrating a system environment 100 of an example telecommunication network 110, according to an embodiment. The system environment 100 includes the telecommunication network 110, which includes two or more network nodes 120, a network management system 130, a second network 140, and a telecommunication network administrator device 142. In various embodiments, the system environment 100 may include fewer or additional components. The system environment 100 may also include different components. The components in system environment 100 may be deployed in one or more physical devices and embodied in software, firmware, hardware, or any combinations thereof.

Telecommunication network 110 may be any communication network that transmits data and signals by any suitable channel media such as wire, optics, waveguide, radio frequency, or another suitable electromagnetic medium. The telecommunication network 110 can be of any scale from near-field to a satellite wireless network, including local area network (LAN), metropolitan area network (MAN), wide area network (WAN), long-term evolution (LTE) network, or another suitable communication network whose scale and area of coverage may not be commonly defined. The components in telecommunication network 110 do not need to be confined in the same geographic location. For examples, the network can be established with nodes that are distributed across different geographical locations. Also, some of the nodes may be virtualized. The telecommunication network 110 includes two or more network nodes 120 that communicate with each other through one or more channels 114, 116, etc. While three example network nodes arranged in a ring are shown in FIG. 1A, telecommunication network 110 can be in any topologies, such as point-to-point, star, mesh, chain, bus, ring, and any other suitable, regular or irregular, symmetric or not, cyclic or acyclic, fixed or dynamic (e.g., with one or more network nodes 120 moving) topologies. The telecommunication network 110 may include wireless communication between network nodes 120 that are carried by (e.g., mounted on, integrated in, or otherwise embedded) building sides, towers, other structures, surface ships, floating platforms at sea, submersible vehicles, ground vehicles such as cars or trains, airborne platforms such as airplanes, balloons, dirigibles, and other fixed- or non-fixed-wing aircraft, space platforms such as satellites, space stations, manned space vehicles, space probes, and other space vehicles.

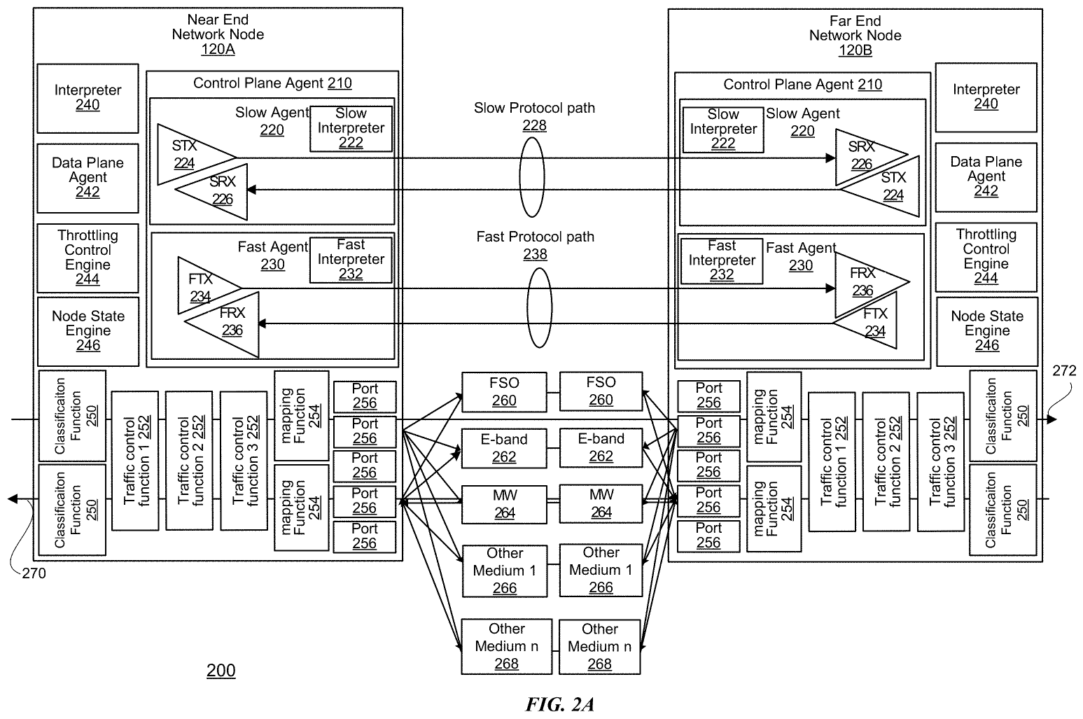

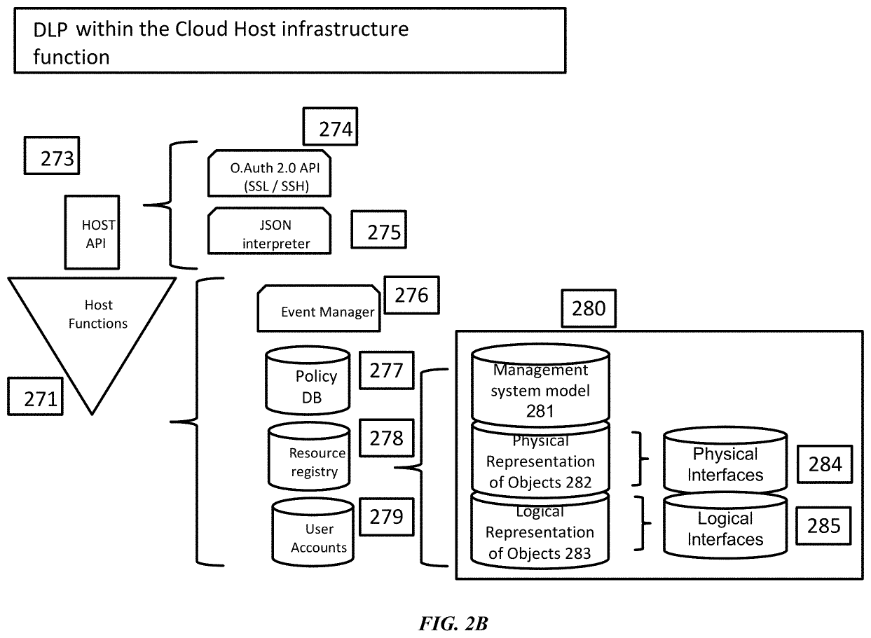

Network nodes 120 may be any suitable distribution points, redistribution points, or endpoints of telecommunication network 110. Network nodes 120 may also be referred to as simply nodes 120 and may take the form of a communication instrument, a base station, a physical node, a virtual switch, a computing node, a cloud resource, or any suitable computing device that is equipped with one or more network protocols. Each network node 120 may include one or more agents 122. Different types of agents 122 in a network node 120 will be discussed in further detail below with reference to FIG. 2A. Network nodes 120 can be any suitable data communication equipment for encoding and transmitting data frames in one or more physical layer channels. Depending on embodiments, one or more network nodes 120 can take form of gateways, routers, switches, hubs, modems, base stations, terminals, wireless access points, Internet of Things (IoT) devices, etc. that may be carried by fixed structures or mobile equipment such as satellites, vehicles, autonomous vehicles, drones, or portable electronic devices. In other words, a network node 120 may be any suitable infrastructure or equipment that may be used to transmit or re-distribute data to another network node 120. The node may also be virtualized and a software-implemented node that can be part of a computing device or a cloud resource. Each network node 120 may communicate with another network node 120 through one or more channels 114, 116, etc. of similar or dissimilar technology types. Channels 114 and 116 can be of any suitable channel media such as free space optical (FSO) communication, E-band, microwave, mobile wireless, fixed wireless, a wired connection, an Ethernet-based transport facility, or another suitable medium. A channel may also simply be the Internet. Channel 114, channel 116, and other channels may also be using the same medium but with different frequencies such as radio frequency using Wi-Fi frequency band, LTE frequency band, ultra-high frequency (UHF) band, etc. Also, the channels 114 and 116 may also use the same type of medium. For example, channel 114, channel 116, and other channels may be several FSO channels with spatial diversity. While all three of the network nodes 120 in FIG. 1A are shown to be connected by channel 114 and channel 116, any pair of network nodes 120 in telecommunication network 110 may be communicated with each other in channels that are different from those used in another pair of network nodes. For example, FSO may be available between some of the network nodes 120, but not between every network node 120.

Telecommunication network 110 may be divide logically, structurally, and/or architecturally into a control plane 150 and a data plane 160. The control plane 150 and data plane 160 are different functional layers of the telecommunication network 110 and may have separate or shared hardware and architecture, but may be separately controlled and maintained through software and sometimes certain separate hardware. Data plane 160 may be the part of the telecommunication network 110 that is used to transmit data payloads. Data payloads are live data traffic that is transmitted by network users through the telecommunication network 110. For example, website data, emails, multimedia data, and other suitable Internet packets may be transmitted through the telecommunication network 110 and are examples of data payloads. Channels 114 and 116 that are used by the data plane 160 are often operated at the line rate or close to the line rate to enable data payloads to be transmitted as fast as possible through telecommunication network 110. Data plane 160 may also be referred to as the bearer plane. Data plane 160 may contain header-based flow identifiers.

Control plane 150 may be a function layer of the telecommunication network 110 that is used to transmit information related to changes, additions, or removal of various settings and protocols of the telecommunication network 110. For example, control plane 150 is used to transmit control messages that are used to adjust the settings of one or more network nodes 120, the entire telecommunication network 110, certain channels 114 and 116, etc. Messages intended for the control plane 150 may be referred to as control plane messages, which may carry parameters and/or instructions to change one or more settings of a component in the telecommunication network 110. One example of a control plane message may be a message that carries instructions related to a traffic control function. Another example of a control plane message may include a packet or any messages that are intended for layers that are higher than data link layer. A control plane message may also be transmitted from a network node 120 to the network management system 130 and carry state information (e.g., status information) or feedback information of a component of a network node 120. Types of control plane messages may include operational messages, administration messages, maintenance messages, provisioning messages, troubleshooting messages, etc. The protocol agents 122 may include settings of a component in the telecommunication network 110. The settings may be associated with traffic control functions (TCFs), flow classification functions, mapping functions, quality of service settings, throttling management, traffic management, error control mechanisms, error correction mechanisms, data link layer protocols, multiplexing protocols, delay protocols, rate limits, scheduler types, port settings, virtual LAN (VLAN) settings, physical layer encoding protocols, physical layer error correction schemes, etc. Control plane messages are distinct from data payloads transmitted in the data plane 160 and are used to control the telecommunication network 110. It should be noted that the term control plane message may apply to protocol, configuration, and signaling messages between the agents (both fast and slow), and between the TCFs which can be mapped or encoded into the fast and slow agents.

Control plane 150 used in this disclosure may include both a control plane and a management plane. For example, in some embodiments, a control plane may handle control and protocol messages that are intended for sharing among network nodes 120 (which may be commonly referred to as east and west bound messages). A management plane, on the other hand, may handle control and protocol messages that are originated from a device outside the telecommunication network 110 or from a third party through the network management system 130 (which may be commonly referred to as north bound messages). In the embodiments that further divide control plane 150 into a control plane and a management plane, the messages intended for the management plane may be referred to as operations, administration, or management (OAM) messages. However, for embodiments that further divide control plane 150 into a control plane and a management plane, the term control plane message may include both messages intended for the control plane and the messages intended for the management plane, including OAM messages.

Network management system 130 may be a server or any computer that is used to manage the telecommunication network 110. The network management system 130 may transmit one or more administration, control and configuration messages to a network node 120. In one embodiment, the network management system 130 may directly communicate with every network node 120 in the telecommunication network 110. In another embodiment, a network node 120 that received the messages may propagate the messages to one or more other network nodes through the control plane 150. The control plane messages may be intended for all network nodes 120 or a subset of network nodes 120. The network management system 130 may provide a user interface 132 for a network administrator (e.g., a customer that purchases or leases the infrastructure of telecommunication network 110) to control and adjust one or more settings of telecommunication network 110. The user interface may take the form of a graphical user interface (GUI) to provide visual information and data for the network administrator. The network management system 130 may also include an application programming interface 134 (API) for a network administrator to use programming languages to communicate with the network management system 130. The network management system 130 may also communicate with third party systems over which the network administrator device 142 may receive information relevant to network components managed outside of the network management system 130.

A network administrator may use a telecommunication network administrator device 142 to communicate with the network management system 130 through a second network 140. The telecommunication network administrator device 142 may be one or more computing devices such as desktop computers, laptop computers, personal digital assistants (PDAs), smartphones, tablets, wearable electronic devices (e.g., smartwatches), smart household appliance (e.g., smart televisions, smart speakers, smart home hubs), Internet of Things (IoT) devices or other suitable electronic devices. The telecommunication network administrator device 142 may communicate with the network management system 130 through the user interface 132 and/or API 134. The second network 140 may be any suitable network such as the Internet, 4G, LTE, 5G, LAN, or a direct line. Telecommunication network 110 may or may not be part of the second network 140. In one embodiment, a network administrator may remotely control the settings of the telecommunication network 110 through sending commands via the Internet to the network management system 130. For example, a network engineer of a telecommunication company may control the telecommunication network 110 using API 134 through the Internet at the engineer's normal place of work. In another embodiment, a network administrator may be local to the telecommunication network 110 and he may control the network 110 through a local area network (e.g., WI-FI) or even a direct ethernet cable. As discussed in further detail below with reference to the section “Management of Telecommunication Network” below, a network administrator may dynamically change settings of telecommunication network 110.

FIG. 1B shows the locations where a host API or a host function is deployed on a DLP host to support the Cloud resource function. FIG. 1B illustrates a cloud, network functions virtualization (NFV), or software defined networking (SDN) system architecture. Each of the host A 102 and the host B 103 may be a computing device or a cloud computing node. The hosts 102 and 103 provide host functions and host API 101 for the management of the production network (e.g., bearer path) that provides data to customers. The hosts 102 and 103 may take the form of infrastructure and virtualization layers. The production network may be associated with a policy aware firewall 104. Various controllers and administrators may control the production network through the host functions and API provided by the hosts 102 and 103. Examples of the controllers and administrators may include IAM policy controller 107, EMS/NMS/NFV manager 106, and orchestrator 105, which may take the form of a multi-host control layer. In a network 100 shown in FIG. 1A, one or more nodes 120 may be part of the function of a host 102 or 103. The configurations of nodes 120, such as their states, settings, traffic control function availability, ports, etc., may be managed through the Cloud using API. Orchestrator 105, EMS/NMS/NFV manager 106, and IAM policy controller 107 can manage the network and the nodes 120 through the API.

### Example Network Node Framework

FIG. 2A is a block diagram illustrating the architecture of two example network nodes 120 in the telecommunication network 110, according to an embodiment. FIG. 2A illustrates an example framework 200 for carrying out various functions and protocol in this disclosure, according to an embodiment. The two example network nodes 120 may be referred to as a near end network node 120A and a far end network node 120B. Near end network node 120A represents a transmitting side of a network and far end network node 120B represents a receiving side of the network. In a fully duplex network, near end and far end network nodes may be equivalent. Unless further specified, these network nodes may simply be referred to as network nodes 120. Near end network node 120A and far end network node 120B may also simply be referred to as a first network node and a second network node. For a message that is received at a far end network node 120B, the message may be intended for the far end network node 120B and/or intended for another network node 120 in the telecommunication network. If the message is intended for the far end network node 120B, the far end network node 120B will process the message. If the message is intended for another network node 120, the far end network node 120B will become the near end network node 120A for the next round and forward the message to another network node 120. The message can be a control message or a data message.

A network node 120 may include a control plane agent 210, an interpreter 240, a data plane agent 242, a throttling control engine 244, a node state engine 246, and ports 256 that include or are connected to channel equipment (e.g., antennas, laser transmitters, waveguides, cables) for transmission of signals. The control plane agent 210 may be a data link layer agent. In various embodiments, a network node 120 may include fewer or additional components. A network node 120 may also include different components and the functionality of each component may also be distributed to another component or among other components. Each component may be implemented using a combination of software and hardware. For example, each network node 120 may include memory for storing instructions that define one or more software engine and one or more processors for executing the instructions to perform one or more processes described in this disclosure.

A control plane agent 210 is a data link layer agent that may be implemented as a software engine that is executed on one or more types of processors for different computations and functionalities. The control plane agent 210 manages the protocols, traffic control functions, and frameworks for transmitting and routing control plane messages to various network nodes 120. The control plane agent 210 may include a slow agent 220 and a fast agent 230 that may be run on the same or different types of processors to transmit and process messages at different speeds. For example, in one embodiment, the slow agent 220 includes instructions that are executed on a generic processor such as a central processing unit (CPU) to process and route regular control plane messages. The fast agent 230 includes instructions that are executed on a specialized processor such as a network processing unit (NPU) that may be also used by the data plane. In another embodiment, the fast agent 230 may be run on a field-programmable gate array (FPGA) or another suitable processor. Control plane messages processed by the NPU may be expedited and transmitted using a fast protocol path 238 at the line rate of a channel or the rate of data plane 160. The slow agent 220 may transmit messages using a slow protocol path 228 at the rate of the control plane 150 that is set by the administrator of the telecommunication network 110. The slow agent 220 includes a slow transmitter function 224 and a slow receiver function 226. The fast agent 230 includes a fast frame header insertion function 234 and a fast frame header retrieval function 236. The slow agent 220 may transmit messages with payloads using Ethernet frames.

Interpreter 240 may be implemented as a software engine that is executed on one or more types of processors for deciding various protocols, functions, ports, channels, quality of service (QoS) requirements. The interpreter 240 may be run on a processor separate from the processors used by slow agent 210 and the processor used by fast agent 230. A control plane message may include mapping information associated with how the control plane message should be transmitted. For example, part of the mapping information may take the form of metadata of the control plane message. In some cases, part of the mapping information may also be inherent in the type of control plane message and/or sender of the control plane message. Interpreter 240 may receive and map TCF-related control plane messages to the slow agent 220 or the fast agent 230 for transmission to a far end network node 120B. At the far end network node 120B, the slow agent interpreter 222 or the fast agent interpreter 232 reverses the process to map the TCF-related control plane messages to the related TCFs.

The control plane agent 210 controls and holds the configuration for the flow mappings from the classification function 250 to map information payload and control plane messages into a path (e.g., one or more channels using one or more ports 256) and QoS treatment to provide the basis for applying switching, mapping, and/or traffic control to specific traffic classification. The control plane agent 210 may also use mapping functions to provide the system for implementing routing of network traffic across one or more network nodes 120 or utilization of one or more network nodes 120 based on classification and QoS treatment of traffic flows. The control plane agent 210 may also determine one or more traffic control functions 252 (e.g., the type of automatic repeat request (ARQ), repetitive messages sent across different channel media, etc.) for information payload and control plane messages. In one embodiment, interpreter 240 may include a slow interpreter 222 that is run on a CPU and a fast interpreter 232 that is run on an NPU.

The fast agent 230 may be implemented in the data plane and be a part of the data plane agent 242, which may be a data link layer agent that may be implemented as a software engine that is executed on one or more types of processors. The data plane agent 242 transmits data payloads of the telecommunication network 110 and control plane messages with special headers that are treated as part of the data traffic. In one embodiment, to increase the speed of transmission and data processing of information payloads, the data plane may be run on an NPU. The fast agent 230 may be used to transmit control messages but use data plane resources to increase the speed of transmission.

The throttling control engine 244 controls the traffic of one or more channels of a network node 120. In some cases, throttling control engine 244 may limit the bandwidth of a particular user or a particular channel to ensure the traffic associated with the user or channel does not overburden the system. The node state engine 246 monitors the status of a network node 120, including the status of ports, links, the control plane and the data plane. The node state engine 246 also monitors the status and activities of each channel. The throttling control engine 244 may provide flow pushback to ports based on the status information provided by node state engine 246.

For example, the throttling control engine 244 obtains state information on each physical and/or logical link on the network nodes 120, or the node uses a third-party channel, for the purposes of modifying flow rates through the DLL link. The throttling control engine 244 makes decisions based on the state information, information in the configuration of the services held in the data plane 160, settings on the control plane agent 210 on how to perform flow control, or push back to restrict bandwidth rates at the network side of a network node 120 when congestion situations are encountered. The network-side port may provide end-to-end flow information. The network-facing ports may use mechanisms such as PAUSE in mapping and pause detection function, and other IP or Ethernet type congestion signaling to communicate flow control is needed by the network nodes 120.

In the embodiment shown in FIG. 2A, the network nodes 120 may communicate with each other through more than one channel. Example channels may include FSO communication 260, E-band 262, other radio frequency such as microwave (MW) 264, and additional channel media 266 and 268. The channels 260, 262, 264, 266, and 268 in FIG. 2A are examples of channels 114 and 116 in FIG. 1. The particular types of channel media (e.g., FSO and E-band) are merely shown in FIG. 2A as examples. Channels between two network nodes 120 in any embodiments may include zero to multiple FSO 260, zero to multiple E-band 262, etc. Also, among network nodes 120, there can be different types of channels between any two network nodes 120. For example, some network nodes 120 may have the same channels, while other network nodes 120 may have different channels in a telecommunication network 110. In a telecommunication network 110, a pair of network nodes 120 may be fully duplex, as represented by arrows 270 and 272. However, in some embodiments, some of the network nodes 120 may also be half duplex or simplex.

The classification functions 250, traffic control functions 252, and mapping functions 254 may include customizable variables that may be stored in a memory of a network node. Those functions may be adjustable to allow a network administrator to quickly change the settings of network nodes 120 so that those functions become “hot modifiable.” The agents, engines, and other configurations of network nodes 120 may be configured by the network management system 130 by adjusting those functions. Those functions affect how a control plane message or an information payload is transmitted across the telecommunication network 110 such as the channel used, the ARQ used, etc. For example, a telecommunication network administrator device 142 may send a new transport control function or a change in a transport control function to telecommunication network 110 through network management system 130.

The framework 200 of a network node 120 shown in FIG. 2A allows the telecommunication network 110 to implement mapping and management of network traffic across one or more network channels and nodes 120. The framework can be used to address issues with FSO channel stability, but the framework can be applied to different types of data link layer functions, link aggregation, SDN, NFV, IoT, Cloud, other solutions that use VPN, and link protocols where trunk or link aggregation type methods are implemented. The framework allows a telecommunication network 110 to perform various functions required to classify, map and un-map traffic into link flows, while providing the ability to add and subtract traffic control functions on-demand or at will.

The implementation method may utilize transmission, switching, and aggregation nodes architectures and be deployed in a single device or multiple devices. More particularly the method involves traffic classifications, mapping, QoS treatment, and data link layer functions and other functions used across a link or plurality of links to provide better service performance, and the ability to dynamically change the traffic control and mapping functions used on the traffic itself.

The network node 120 implements software-defined, highly configurable, and customizable data link layer transmission and QoS control mechanisms to provide resilience to media subject to packet loss such as FSO and unregulated Wi-Fi. A network node 120 provides management and control plane features that provide fully customizable and extendable QoS treatments for data plane 160 via modularly defined transmission and QoS mechanisms that can be used to maintain and handle traffic flows across one or more channels.

A network node 120 includes a data plane agent 242, a control plane agent 210, a throttling control engine 244, and a node state engine 246 that are used to manage traffic between two network nodes 120. The network node 120 may include various functions such as an event and messaging function, classification, flow control, and pushback function, traffic control functions and link management, and mapping and pause detection functions that cooperate to configure and reconfigure the data plane functions. Those functions may be configured by the network management system 130.

The DLP protocols can be used to send control plane messages via a slow protocol path 228 or a fast protocol path 238, according to an embodiment. A control plane agent 210 may receive or generate one or more control plane messages. A network node 120 may receive a message when the message is transmitted from another network node 120. The message may also be originated from the network node. A control plane message may belong to the control plane 150 that is from a TCF 252. The control plane agent 210 may also receive mapping information associated with how the control plane message should be transmitted. For example, the mapping information may be a set of parameters that are part of the metadata of the control plane message. In some cases, the mapping information includes port information, traffic control functions to be used, and QoS specification. The interpreter 240 determines, based on the mapping information, whether the control plane message is to be sent via the control plane 150 or the data plane 160. The interpreter 240 may make the determination by inputting one or more parameters of the control plane message to the mapping function 254 to decide whether the control plane message is to be sent by which single or plurality of links. In some embodiments, the telecommunication network 110 includes a plurality of channels. The interpreter 240 may determine the states of the channels. The interpreter 240 then determines a mapping of the control plane message based on the mapping information and the states of the channels to determine whether the control plane message is to be sent via alternative paths when link outages occur.

If the interpreter 240 decides that the control plane message is to be sent by data plane 160, the control plane message is processed by the fast agent 230. Fast agent 230 is a control plane agent but uses data plane resources to transmit the control plane message. In response to a determination that the control plane message is to be sent via the data plane 160, the fast agent 230 may first encode the control plane message. For example, the fast agent 230 may turn the control plane message into a shorter message based on a particular mapping and classification scheme that may be defined in mapping function 254 and classification function 250. The fast agent 230 may insert the shorter message as a structured header in a data plane frame. The data plane frame may or may not include data payload of regular user traffic and a section of the data plane frame is utilized to carry control plane messages. For example, in one embodiment, a fast agent frame contains only header without payload so that the frame is small and can be transmitted really quickly. Sometimes the fast agent frame may be transmitted in the middle of two regular payload frames. The data plane frame has a marking signifying that the data plane frame carries the control plane message. In one embodiment, the marking may be part of the header and may assign values based on the control plane message type. In one embodiment, the header may include two sections that are used to encode the control plane message type. The first section may include the path identifier of the control plane message. The second section may include the QoS level identifiers of the control plane message. In one embodiment, the encoded frame (e.g., with a header that is coded with the type of control plane message) may be referred to as a codified frame that is in a specific format. In one embodiment, the specific format of the data plane frame complies with the Ethernet frame standard. In various embodiments, the fast agent 230 may also insert the control plane message or an encoded shorter version of the message into another part of a data plane frame. For example, if a control plane message includes information that may not be easily encoded to fit the space of a header, the control plane message may also be put in the body of the data plane frame.

The network node 120 transmits the data plane frame via the data plane 160 by injecting the data plane frame into a traffic of data payload frames. Data payload frames are normal information traffic of the data plane 160. The data plane frame that carries a version of the control plane message (e.g., the control plane message itself or an encoded shorter version) is identified by the marking. By transmitting a control plane message through the data plane 160, the control plane message can be propagated to other network nodes 120 in the telecommunication network 110 at line rate of a channel or close to the line rate. As a result, control plane messages can be transmitted quickly in the network and various customizable functions, such as a network traffic control function, of the network nodes 120 can become “hot modifiable” by virtue of using the reserved header space and/or different control plane messages.

At a far end network node 120B, the network node 120B receives a plurality of frames transmitted via the data plane 160. The network node 120B determines that one of the received frames includes the marking (e.g., the special header) as the data plane frame that encodes the control plane message. The network node 120B returns the control plane message to a part of a flow of the control plane 150 based on the mapping information associated with the control plane message. The network node 120B may also determine that other frames in the received frames that do not include the marking as the data payload frames and continue to route those data payloads through the data plane 160. In one case, if a marking is found in a data payload frame, the structured header that carries the control plane message is stripped off. The control plane message is forwarded to control plane 150. The rest of the data payload frame is routed through the data plane 160.

If the interpreter 240 decides that the control plane message is to be sent by control plane 150, the control plane message is processed by the slow agent 220. The slow agent 220 generates a control plane frame that encapsulates the control plane message. The network node 120, in turn, transmits the control plane frame via the control plane 150. In some cases, the network node 120 (or a channel of the node) may toggle between two states. In a first state, the data plane 160 has data traffic. In a second state, the data plane does not have data traffic. In the first state, the control plane message may be sent through the data plane 150 by injecting the data plane frame that carries the control plane message into the live traffic. In the second state, the control plane frame may be sent via the control plane 150 or be sent via the data plane 150 during a lapse of data plane traffic.

The network node agents' ability to map messages to the fast or slow agent, combined with the extendibility of interpreter using type and/or other information to add, remove, or adjust TCFs statically or dynamically by the agent or externally via API interfaces, creates a framework that supports a plethora of other network functions outside of data link layer transmission and quality control. Natively the framework can be used to support any data path function. For example, security functions such as encryption functions can be treated as TCFs where functions are configured via the agent by mapping traffic through the agents. The end-to-end security control may be passed through the fast or slow paths via a type of TCF or other delineation. Any paired or standalone (e.g., single end function) function can be treated as a TCF by the agents and the data may be sent as control plane messages. The functions may be added on-demand dynamically provided the function has a TCF type that allows the information to be mapped across one or both of the agents.

The adaptability of the frame in accordance with an embodiment will be apparent to one skilled in the arts of service chaining where a function may be a sub-component of an overall traffic service. The agents can dynamically add and/or remove TCFs, any other applications, or functions from the data plane via re-configuring the mapping elements and the setting up of the interpreter and flow. This enables the framework to host Cloud functionality as part of the protocol, as well as SDN, IoT, AIN, Machine Learning, and AI. Each of these functionalities may use system functions distributed along the transmission path. The framework may be extended to support new functions. The signaling may be mapped to the path best suited for the requirements of the control plane message.

FIG. 2B identifies some of the various attributes of a DLP node within a host function 101, according to an embodiment. Each resource or function is contained in the host registry 271 along with varied data models to support using the resource. The host function 101 includes a host API 273, which includes a secure access method 274. The secure access method 274 may leverage API standards such as O.Auth to provide secure communications between the host API and a network administrator who is accessing the host. O.Auth includes an authorization method for identifying who the network administrator is and what privileges the network administrator has. The host API 273 may also provide a JSON (JavaScript Objection Notation) interpreter 275 that acts as a messaging gateway between the HTTP RESTFUL messages used between the host and the network administrator. The JSON interpreter 275 may map messages to resources under the host.

“Compliance” may be related to the process and methods to ensure that only the appropriate network administrators have access to the correct resources and data. Service and platform compliance is provided to the customer and the cloud provider by having the capability to audit who has what privileges on those resources at any given point. Auditors and third parties are also leveraged to obtain higher forms of compliance certification. The framework used to support audit for compliance in large scale cloud systems leverages the IAM (Identity, Access Management) framework, whereby a centralized IAM server holds the accounts for users along with their privileges. The centralized IAM server may include a “host function” option to inter-work with the host API's to regulate access and control of resources. In general, the “policy” framework in the cloud is composed of the IAM server with the user accounts and privileges, which inter-work with the host resources to regulate access control to host resources. Auditing these systems yields compliance compatibility.

With reference to FIG. 2B, the IAM system updates user privileges based on the resource registry in the host via the policy database 277. This allows customers and systems to connect to the resource using HTTP. The JSON interpreter 275 converts the JSON command requests from the HTTP to resource commands via the host API functions. The IAM system supports resources in the format of registries (blocks 276 thru 285) that represent the resource, its attributes, parameters, policies, access control, management systems, sub-components, and commands that can be performed on each resource, interfaces, connections, and any object-oriented states. The registries allow the resources to appear in a cloud portal or be used by applications and compliance. Example registries include event manager 276, policy database 277, resource registry 278 and user accounts 279. The resource registry 278 stores entries of resources in a network that is implemented through the Cloud. The resources may be a DLP node with DLP functionality and protocols, such as a fast agent, a slow agent, and features such as fast failover recovery through the fast agent. The resource registry 278 includes management system model 281, physical representation of objects 282, logical representation of objects 283, physical interfaces 284, and logical interfaces 285. The management system model 281 stores configurations of the resources. A resource can be physical (e.g., a physical node such as a base station) or logical (e.g., a virtualized node such as software-implemented node in a cloud computing device).

### Example DLP Network, Components, and Resources

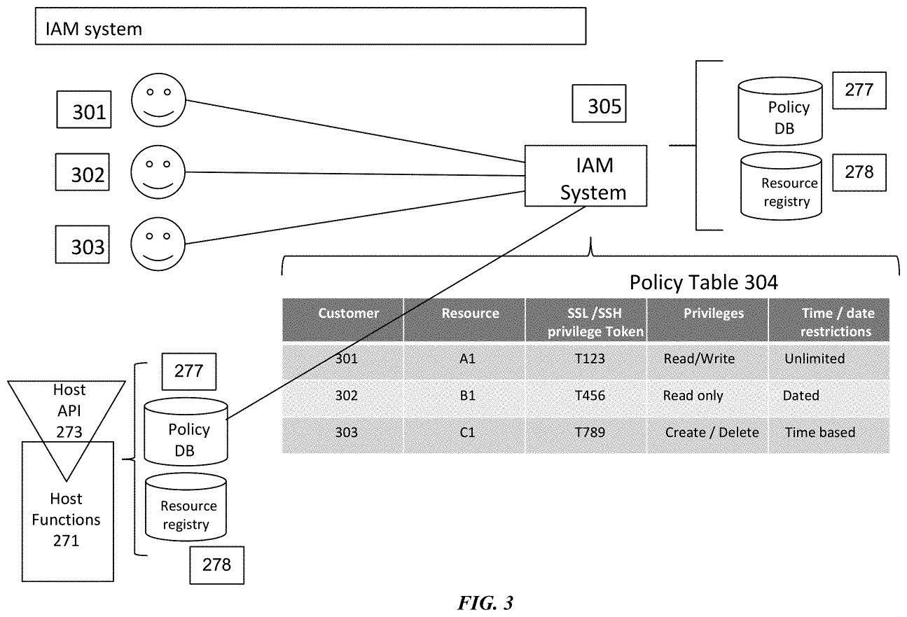

With reference to FIG. 3, an identity, access, and management system (IAM system) is illustrated, according to an embodiment. The IAM system 305 may be part of the functions of one of the hosts 102 or 103 but may manage access of various hosts 102 and 103. The IAM system 305 contains a list of the hosted resources related to customers (which may be administrators) 301, 302, and 303. The resources, such as the accounts of each customer, may be stored in policy database 277 and resource registry 278. The IAM system 305 may assign privileges per customer account or per customer role, such as under the ABAC and RBAC framework. Policy table 304 depicts a policy record, which may take the form of a POLICY.JSON file that is shared with the host supporting the resources for local access control Each customer resource policy record may include security tokens so that the IAM system 305 may manage token via expirations, dates, and other methods to automatically change the customer privileges, including removing or making all tokens refresh or re-authenticate when security access has become untrustworthy. The security systems may be integrated with the IAM system for advanced token policy management. In the case that customers 301, 302, and 303 are administrators, they may manage the node setting and network setting of a network through the Cloud using the IAM system 305 under the privileges each administrator has in adjusting the network.

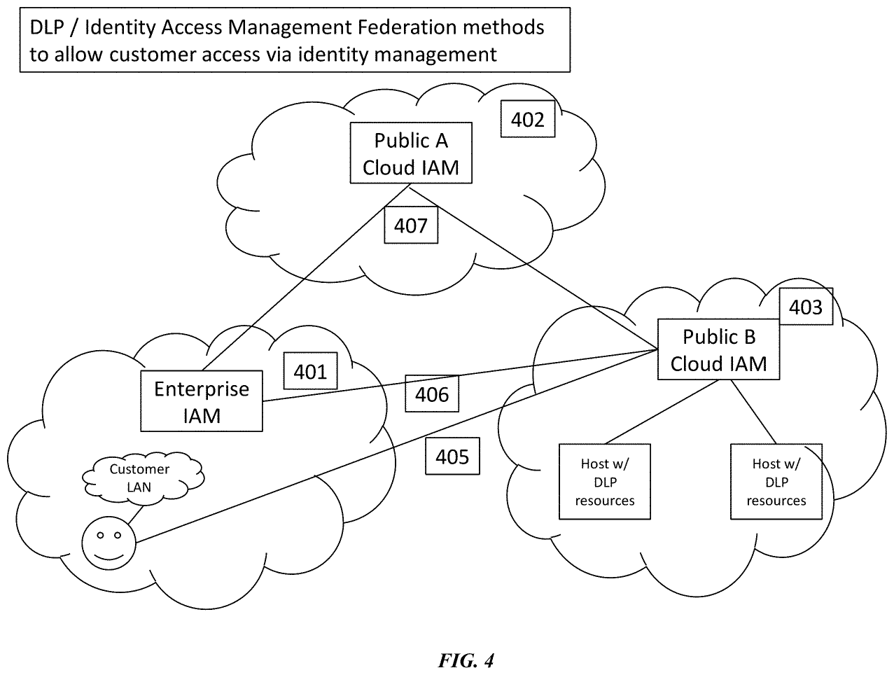

FIG. 4 depicts federation of a DLP system and related resources via IAM federation where a customer can use the customer's local sign-on authentication of enterprise IAM identity to access resources on another cloud platform, according to an embodiment. The other cloud platform may be a DLP resource on a provider network. The various DLP systems may be described as a public, private, or hybrid cloud service. Accounts can be placed directly on the hosting public DLP IAM. The IAM systems can be interlinked via account registry linkage. The combined capability of the host function policy files and the IAM policy files enable the federation of services to a customer. The cloud providers, or even the customer, may create accounts at will to give resource control to their employees without involving the network provider.

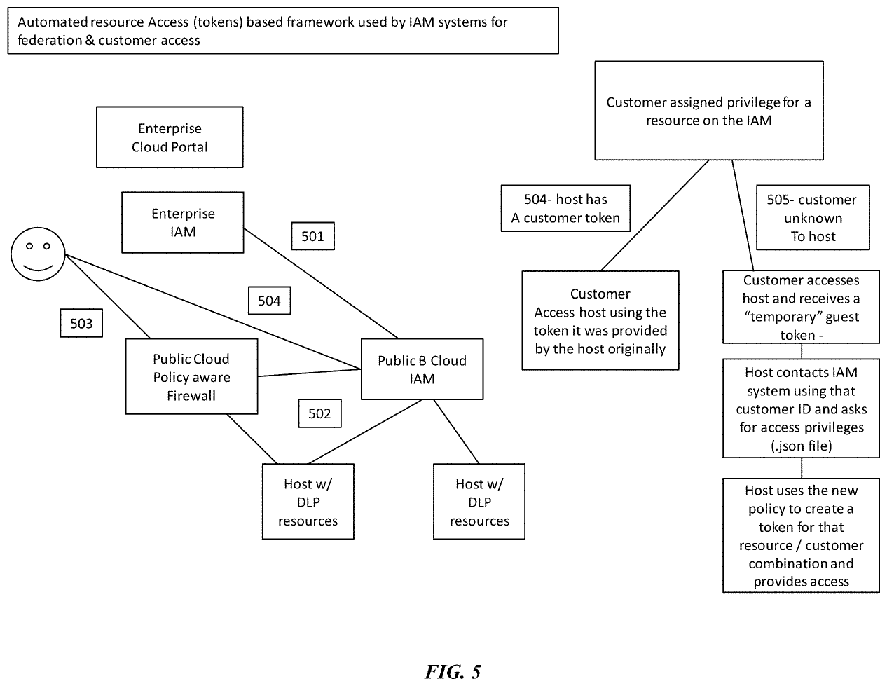

FIG. 5 is a block diagram illustrating an automated resource access (e.g., tokens) based framework used by an IAM system for federation and customer access, according to an embodiment. The path and system interaction for this process is illustrated. The automatic host privilege updates are facilitated by the IAM system by providing a guest token to a customer while the customer queries the IAM system for the user privilege. A customer, such as a network administrator may be assigned with a level of privilege for a resource on the IAM system. The IAM system determines whether the customer has a token. If the customer has a token, in step 504 the IAM system provides the customer with access to the host using the token that was provided by the host originally. If the customer does not have a token, in step 505 the IAM system provides a temporary guest token to the customer. The host contacts the IAM system using the customer identifier and asks the IAM for access privilege. The host uses the new policy to create a token for the resource-customer combination and provides access to the customer.

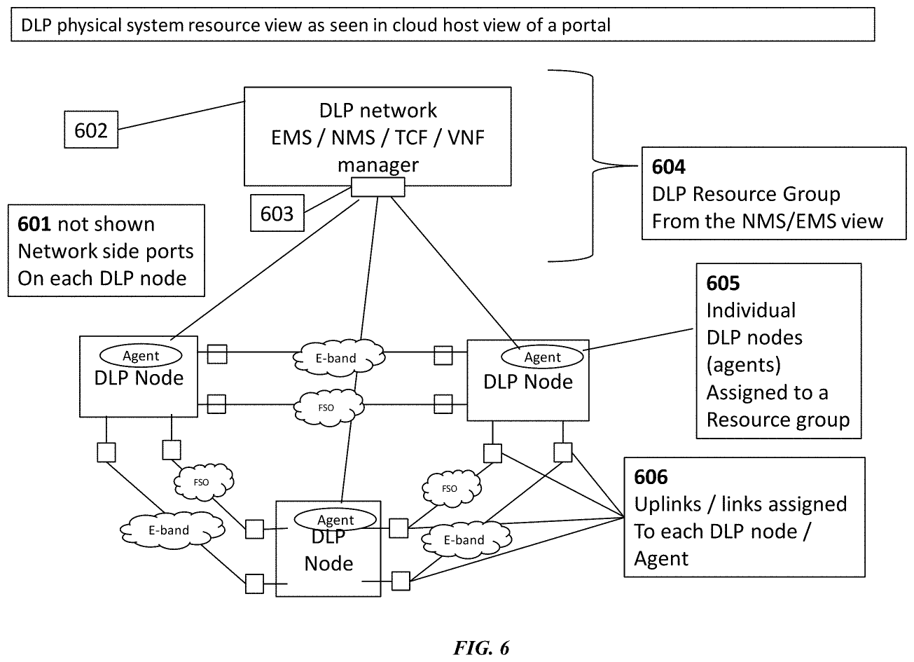

FIG. 6 illustrates a DLP physical system resource view in a cloud host view of a portal, according to an embodiment. Orchestrators and applications can graphically depict the DLP resource model using the host resource registry information which contains the physical and logical representation of the resource group, individual nodes, paired links, and so on. A telecommunication network using the host system is hot configurable through an API or an administrative portal. A network administrator may assign DLP nodes to a resource group, specify links between two nodes, define topology of the network, configure settings such as QoS and other network settings for the network. The administrative portal may provide a graphical illustration of the physical system resource. While in FIG. 6 the example shows only 3 nodes with each node having two communication links (FSO and E-band), the network administrator may select different links for each node from a list of available links, include additional nodes, and customize topology of the network. The resulting physical view of the resource models contained within the host function can then be constructed. Various network resources (e.g., nodes, links, ports, agents, control functions, other physical or logical resources) may be located on a single node or on separate elements. The physical model representation may show how the actual deployment is configured.

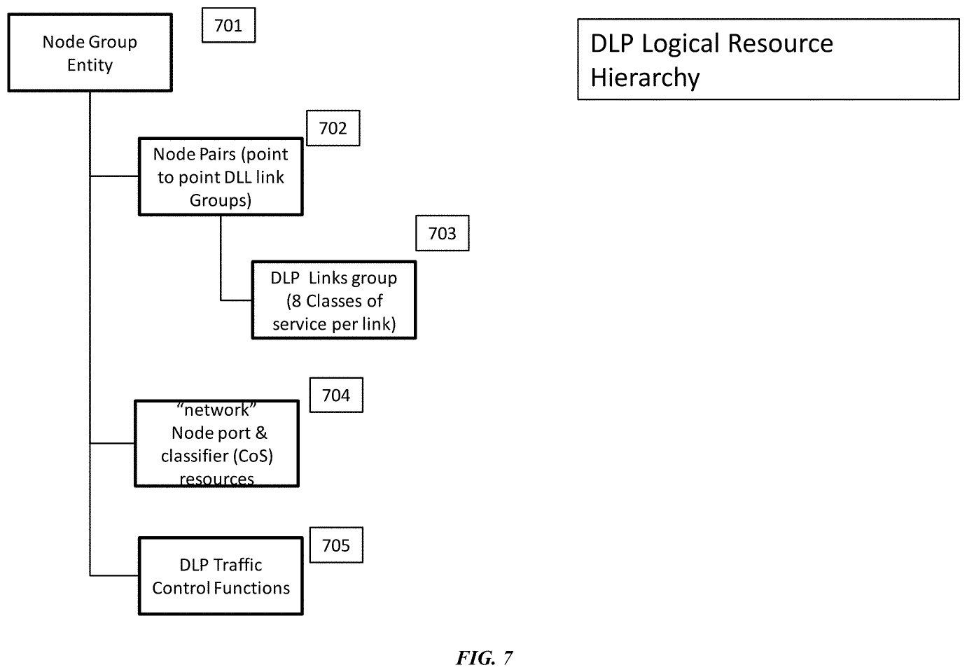

FIG. 7 illustrates an example of DLP logical resource hierarchical tree, according to an embodiment. A node group entity 701 may include node pairs 702, network node port and classifier 704, and DLP traffic control functions 705. The node pairs 702 may take the form of point to point datalink groups 703, which may include 8 classes of service per link. The network node port and classifier 704 may include class of service (CoS) resources. The hierarchical tree illustrated in FIG. 7 is merely one of the examples of how logical resources may be arranged and classified among various embodiments.

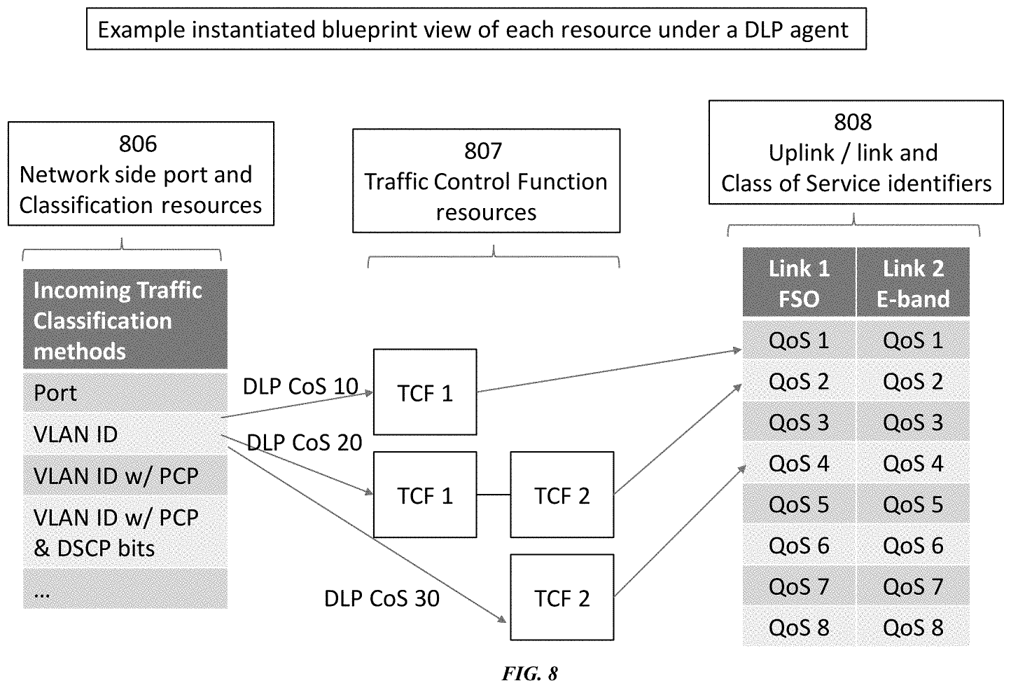

FIG. 8 illustrates an example of instantiated blueprint view of each resource under a DLP agent. For example, the DLP agent may have a setting that allows a network administrator to configure network side port and classification resources 806, traffic control function resources 807, links, and class of service identified 808. Each DLP agent may include various resources that are available for choosing. The network administrator may determine how to configure the DLP agent based on the available choices. A graphical user interface can be used to display the connected parameters and topology parameters stored in the resource. For example, the network administrator may query the host function to retrieve the information and the graphical representation of the relationships of the resources.

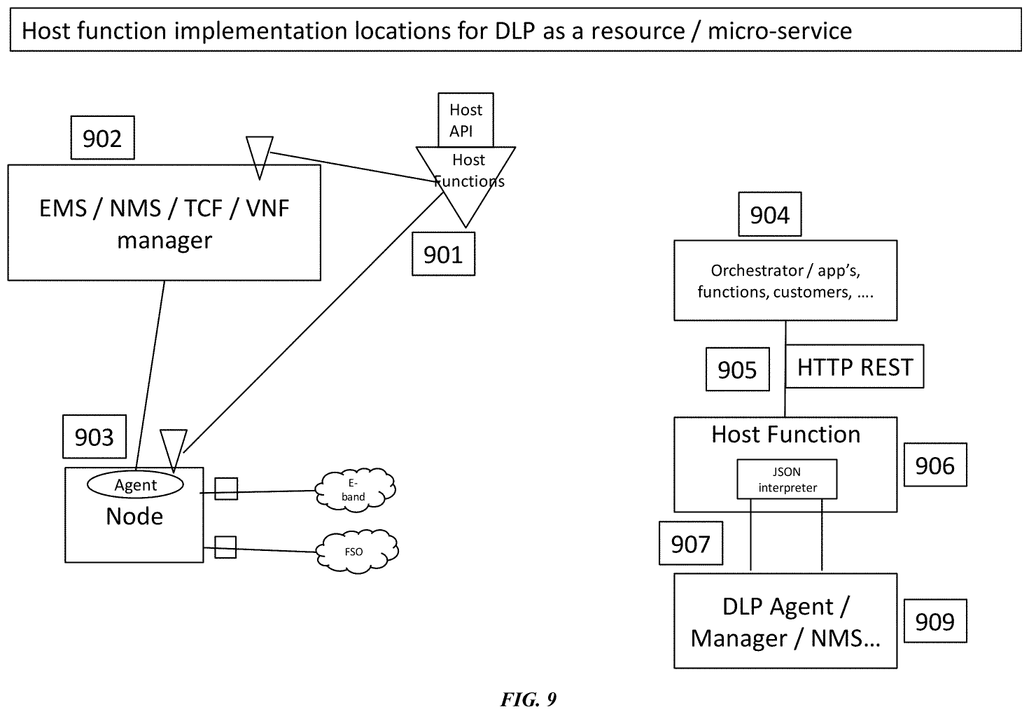

FIG. 9 describes the locations of the host function implementation with respect to the DLP resources where both the DLP node and the EMS/NMS system both have host API. A network administrator may contact the host API via the DLP node or the EMS/NMS system. The DLP node and the EMS/NMS system are in communication and may transmit the OAM settings specified by the network administrator to other nodes in the network.

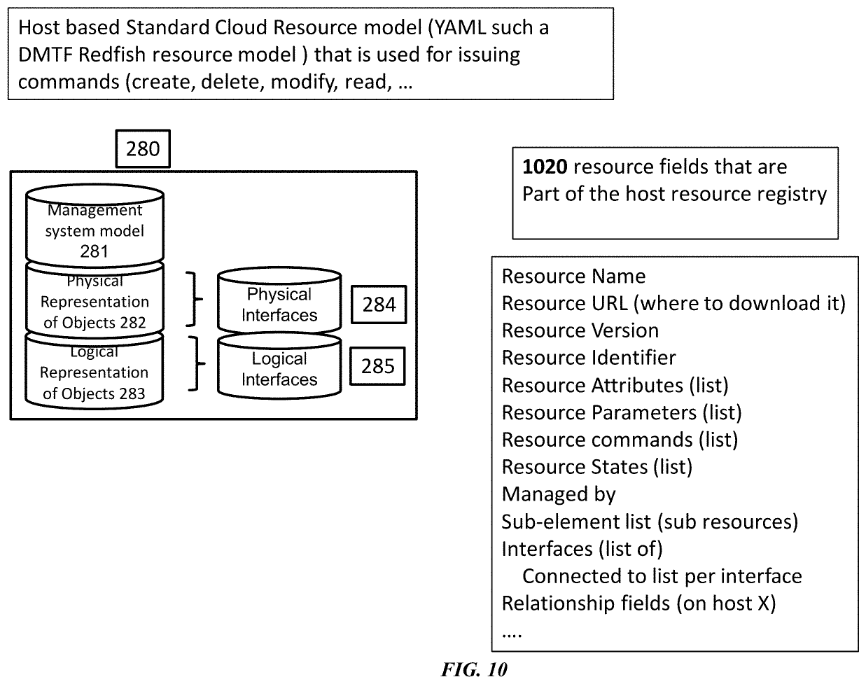

FIG. 10 is a conceptual diagram illustrating how cloud resource models for nodes may be represented, according to an embodiment. The resources may be stored in different models such as management system model 281, physical representation of objects 282, logical representation of objects 283, physical interfaces 284, and logical interfaces 285. The resources may be defined by different resource fields that are part of the host resource registry. The DLP systems and sub-resources may be represented under the object storage patterns using the various fields illustrated in FIG. 10. Cloud implementations may use the OASIS YAML protocol language to enable orchestrators and hosts to communicate the model constructs so that the model constructs are machine readable and can be automated.

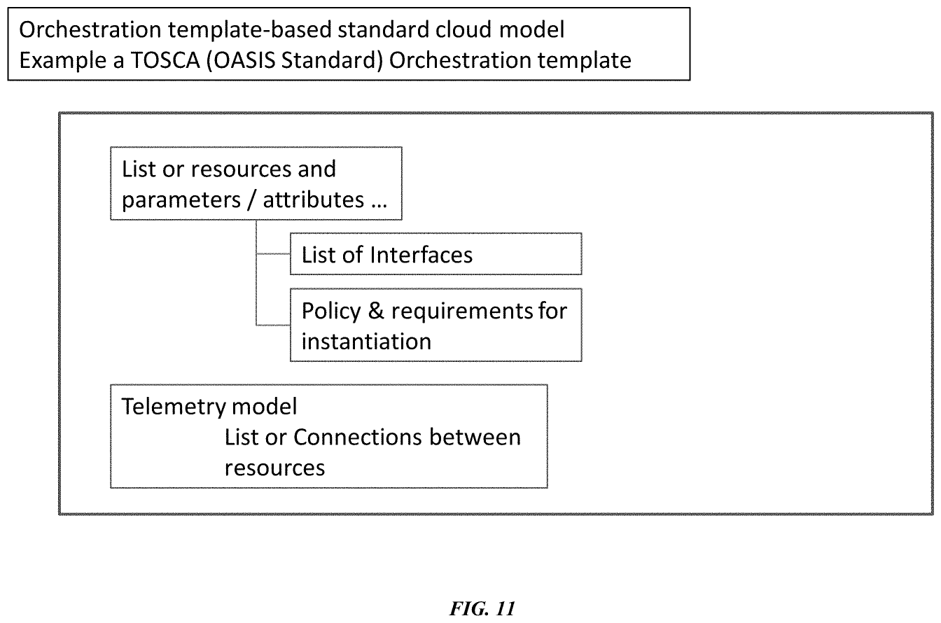

FIG. 11 depicts an orchestrator template which may used for an orchestrator to turn up resources on multiple hosts, according to an embodiment. Specifically, one example here is the OASIS TOSCA (Topology and Orchestration Specification for Cloud Applications) which can be used for applications, physical resources and logical resources. Host resource models are leveraged within this service template to interconnect aggregated resources across multiple hosts. This blueprint or service approach is provided to the customer where a network administrator may choose the parameters with respect to location, bandwidth, and other resource setting in a network. A network administrator may setup a well-defined service such as a DLP link which includes a pair of nodes, DLP agents, and uplinks to create a DLP service. Cloud portals allow a customer to select a service. The cloud portal in turn may provide an interface for the customer to fill out the service options. The federation of complex services leverages the host resource model in the orchestration template but extends the host resource model across multiple hosts.

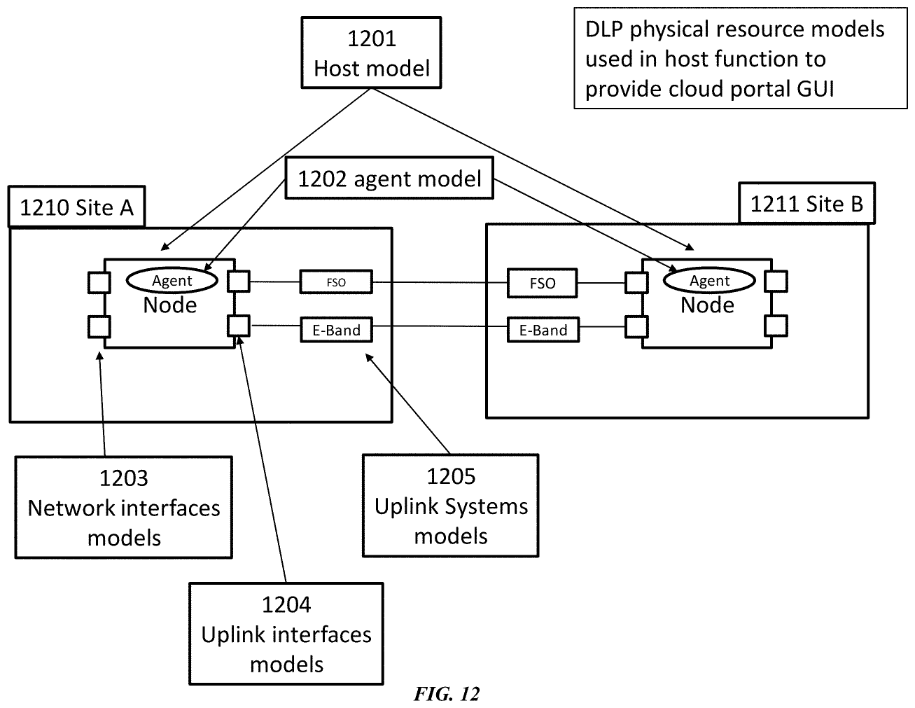

FIG. 12 shows a graphic representation of a multi-host DLP resource model, according to an embodiment. Some of the main major physical resources in the model are also depicted. The multi-host DLP resource may include network interface models 1203, uplink interface models 1204, and uplink system models 1205. The DLP model may also include agent model 1202 that changes setting of each agent in the node.

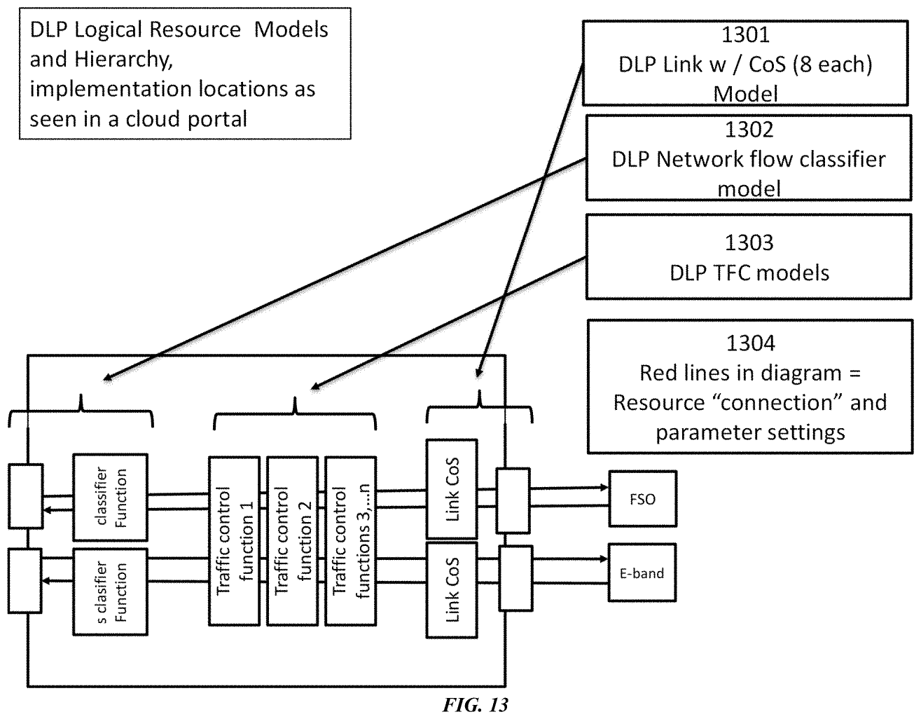

FIG. 13 depicts an example representation of the resources inside a DLP node available for monitoring or configuration via the host, orchestration, and IAM framework, according to an embodiment. Details of the resources are discussed in FIG. 2A with respect to elements 250 through 256. The resources may include DLP link with CoS models 1301, DLP network flow classifier model 1302, DLP TFC models 1303 and other connection and parameter settings 1304.

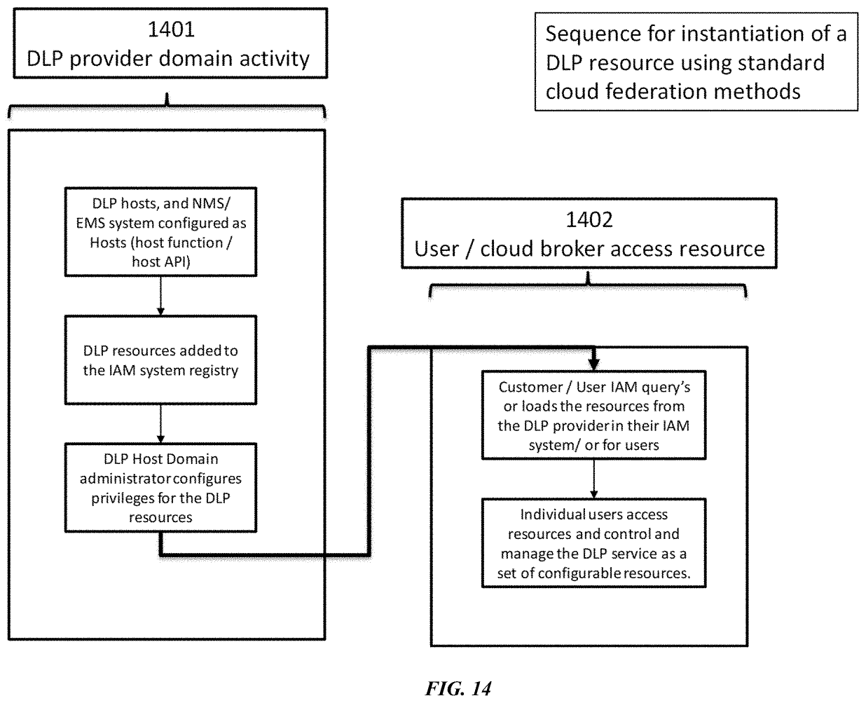

FIG. 14 depicts an example representation of a host provider configuring a service, according to an embodiment. The configuration may include network setting, a set of privileges for a customer (or a customer's IAM system). A sequence for instantiation of a DLP resource using cloud federation methods is illustrated. In one embodiment, the DLP hosts and NMS/EMS systems are configured as hosts of the network so that a host can provide host functions and APIs. DLP resources are added to the IAM system registry. DLP host domain administrator in turn configures privileges for the DLP resources. A customer may use an IAM query to load the resources from the DLP provider using the customer's IAM system via a cloud portal. The host provide may hand the resource over to the customer as part of automated service delivery. The customer may access resources and manage the DLP service as a set of configurable resources.

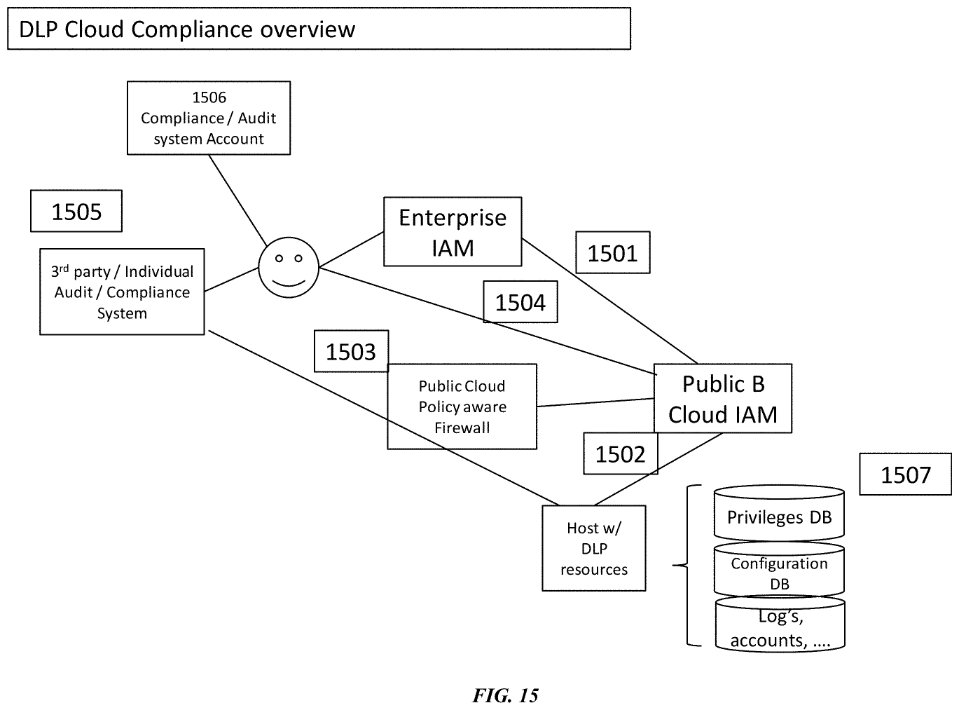

FIG. 15 shows an example embodiment for a user or a third party to operate under a system compliance such as HIPAA, PCI, FEDRAMP, CLEA or lawful intercept, according to an embodiment. The method involves the DLP provider creating an account for the auditor. The auditor may also use an IAM system so that the auditor may be assigned privileges to read configurations, logs, and security policies on the host, and hosting IAM system. The auditor, with proper privileged level, may obtain information of various resources of the network resources.

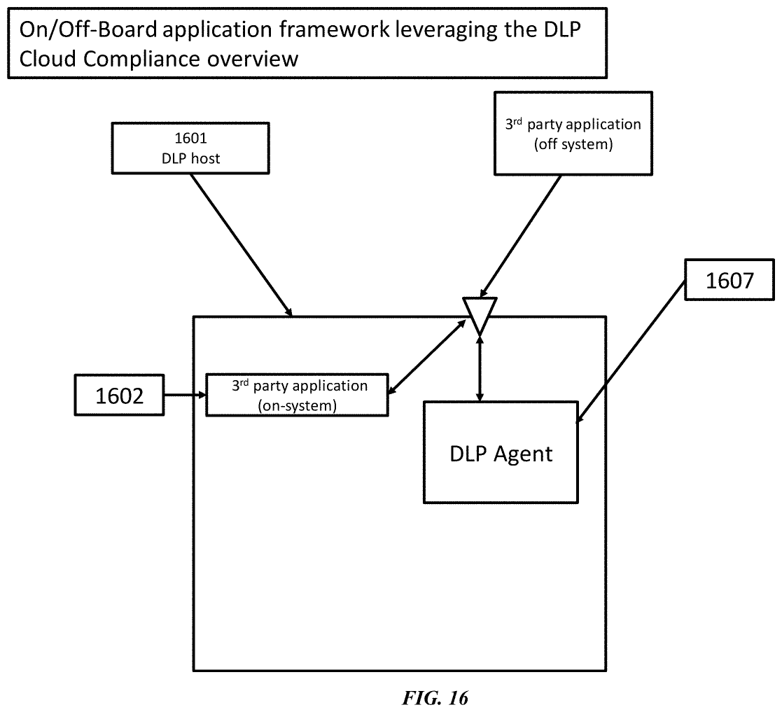

FIG. 16 depicts an embodiment of an on board or off board application framework leveraging the DLP cloud compliance, according to an embodiment. Third party applications may operate on the network or off the network. For an on board application, the application may be located in a DLP node. For an off board application, the application may be located outside of the network but may have controlled secure access to the DLP resource via the host function, such as through host API.

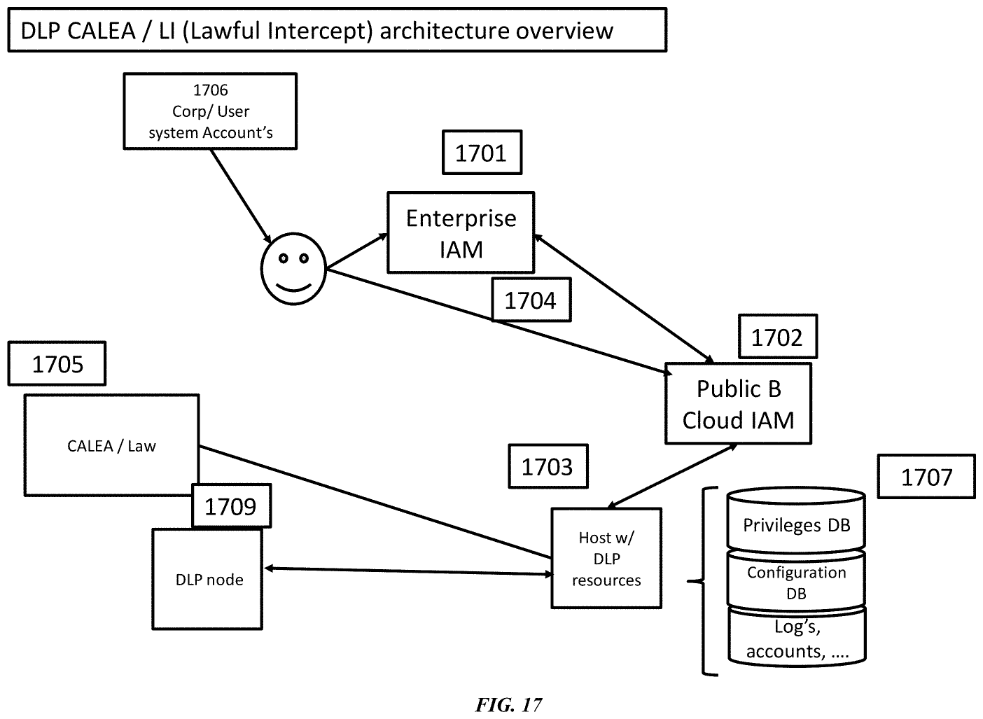

FIG. 17 depicts an example embodiment where DLP resources may be used for lawful intercept, and or CALEA (Commission on Accreditation for Law Enforcement Agencies) type functions where the resources for “replication” of the data stream are only exposed to either network provider security or law enforcement. In this example case, the lawful intercept identifies the user account to have a replication function in the DLP resource added to the flows, which is used to send a separate replicated stream to the lawful intercept DLP node using a DLP header to separate the flows.

### Computing Machine Architecture

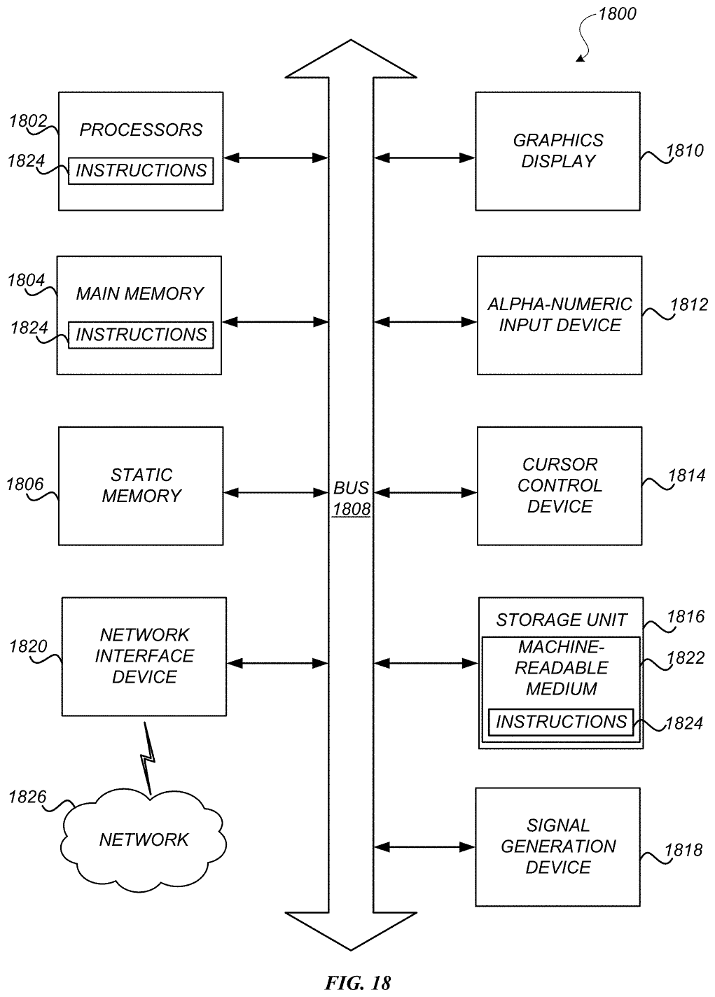

FIG. 18 is a block diagram illustrating components of an example computing machine that is capable of reading instructions from a computer-readable medium and executing them in a processor (or controller). A computer described herein may include a single computing machine shown in FIG. 18, a virtual machine, a distributed computing system that includes multiple nodes of computing machines shown in FIG. 18, or any other suitable arrangement of computing devices.

By way of example, FIG. 18 shows a diagrammatic representation of a computing machine in the example form of a computer system 1800 within which instructions 1824 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 18 may correspond to any software, hardware, or combined components shown in FIGS. 1 and 2, including but not limited to, the telecommunication network administrator device 142, the network management system 130, and various engines and agents shown in FIG. 2. While FIG. 18 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1824 that specify actions to be taken by that machine. Further, while only a single machine is illustrated, the term “machine” and “computer” may also be taken to include any collection of machines that individually or jointly execute instructions 1824 to perform any one or more of the methodologies discussed herein.

The example computer system 1800 includes one or more processors 1802 such as a CPU (central processing unit), a network processing unit (NPU), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 1800 may also include a memory 1804 that store computer code including instructions 1824 that may cause the processors 1802 to perform certain actions when the instructions are executed, directly or indirectly by the processors 1802. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 1802 and reduces the space required for the memory 1804. For example, the processing techniques described herein may reduce the complexity of the computation of the processors 1802 by applying one or more novel techniques that simplify the steps in generating results of the processors 1802. The processors described herein also speed up the processors 1802 and reduce the storage space requirement for memory 1804.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 1800 may include a main memory 1804, and a static memory 1806, which are configured to communicate with each other via a bus 1808. The computer system 1800 may further include a graphics display unit 1810 (e.g., a plasma display panel (PDP), a liquid crystal display (LCD), a projector, or a cathode ray tube (CRT)). The graphics display unit 1810, controlled by the processors 1802, displays a graphical user interface (GUI) to display one or more results and data generated by the processes described herein. The computer system 1800 may also include alphanumeric input device 1812 (e.g., a keyboard), a cursor control device 1814 (e.g., a mouse, a trackball, a joystick, a motion sensor, or other pointing instrument), a storage unit 1816 (a hard drive, a solid state drive, a hybrid drive, a memory disk, etc.), a signal generation device 1818 (e.g., a speaker), and a network interface device 1820, which also are configured to communicate via the bus 1808.

The storage unit 1816 includes a computer-readable medium 1822 on which is stored instructions 1824 embodying any one or more of the methodologies or functions described herein. The instructions 1824 may also reside, completely or at least partially, within the main memory 1804 or within the processor 1802 (e.g., within a processor's cache memory) during execution thereof by the computer system 1800, the main memory 1804 and the processor 1802 also constituting computer-readable media. The instructions 1824 may be transmitted or received over a network 1826 via the network interface device 1820.

While computer-readable medium 1822 is shown in an example embodiment to be a single medium, the term “computer-readable medium” should be taken to include a single medium or multiple media (e.g., a centralized or distributed database, or associated caches and servers) able to store instructions (e.g., instructions 1824). The computer-readable medium may include any medium that is capable of storing instructions (e.g., instructions 1824) for execution by the processors (e.g., processors 1802) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method for hosting a telecommunication network in a cloud environment, the computer-implemented method comprising:
maintaining a resource registry that stores a plurality of resource entries of a plurality of data link protocol (DLP) nodes, each DLP node comprising a slow agent and a fast agent, the slow agent configured to transmit data messages through Ethernet frames and the fast agent configured to transmit control messages through DLP frames, each DLP frame comprising a header only without a payload and the header carrying a control message;
transmitting the resource entries for display at a cloud portal for a customer to adjust a configuration of the telecommunication network;
receiving a change in the configuration of the telecommunication network from the customer; and
transmitting the change to a computing host that implements one of the DLP nodes through an application program interface (API) of the computing host.

2. The computer-implemented method of claim 1, wherein the plurality of DLP nodes are managed by a cloud host as part of DLP resources of the cloud host regardless of whether each of the DLP nodes is a physical or virtual implementation of the DLP node.

3. The computer-implemented method of claim 2, wherein the DLP resources on the cloud host are additionally managed by an external DLP element or a network management system.

4. The computer-implemented method of claim 1, wherein at least a first DLP node of the plurality of DLP nodes is a physical implementation of a network node and at least a second DLP node of the plurality of DLP nodes is a virtualized version of a network node.

5. The computer-implemented method of claim 1, wherein the plurality of DLP nodes are controllable by an element management system (EMS) or a network management system (NMS) that does not use DLP protocol.

6. The computer-implemented method of claim 1, wherein the plurality of DLP nodes are manageable by an administrator via an external element management system (EMS) or network management system (NMS) that communicates to the telecommunication network via an external DLP node that is controlled by the administrator and that connects to the telecommunication network.

7. The computer-implemented method of claim 6, wherein the external EMS or NMS is accessible through an agent only view.

8. The computer-implemented method of claim 1, wherein the cloud portal is part of a cloud identity and access management (IAM) system framework.

9. The computer-implemented method of claim 1, wherein controls of the plurality of DLP nodes are delivered to a new customer through resource federation.

10. The computer-implemented method of claim 1, wherein a plurality of customers are capable of controlling the plurality of DLP nodes through different cloud portals.

11. The computer-implemented method of claim 10, wherein at least a first customer of the plurality customers has a first access privilege for controlling the plurality of DLP nodes

12. The computer-implemented method of claim 1, wherein at least one of the DLP nodes includes a third party audit or compliance access.

13. The computer-implemented method of claim 1, wherein at least one of the DLP nodes includes an on-system access and an off-system access, the off-system access being communicated via the API.

14. The computer-implemented method of claim 1, wherein the plurality of DLP nodes are connected through different network providers.

15. The computer-implemented method of claim 1, wherein the fast agent is configured to inject the DLP frames into traffic of the Ethernet frames.

16. The computer-implemented method of claim 15, wherein the DLP frames are treated as Ethernet frames but without the payload.

17. A system comprising:
a plurality of data link protocol (DLP) nodes, each DLP node comprising a slow agent and a fast agent, the slow agent configured to transmit data messages through Ethernet frames and the fast agent configured to transmit control messages through DLP frames, each DLP frame comprising a header only without a payload and the header carrying a control message;
a cloud computing server configured to:
maintain a resource registry that stores a plurality of resource entries of the plurality of DLP nodes;
transmit the resource entries for display at a cloud portal for a customer to adjust a configuration of the telecommunication network;
receive a change in the configuration of the telecommunication network from the customer; and
transmit the change to a computing host that implements one of the DLP nodes through an application program interface (API) of the computing host.

18. The system of claim 17, wherein the plurality of DLP nodes are managed by a cloud host as part of DLP resources of the cloud host regardless of whether each of the DLP nodes is a physical or virtual implementation of the DLP node.

19. The system of claim 17, wherein at least a first DLP node of the plurality of DLP nodes is a physical implementation of a network node and at least a second DLP node of the plurality of DLP nodes is a virtualized version of a network node.

20. The system of claim 17, wherein the plurality of DLP nodes are manageable by an administrator via an external element management system (EMS) or network management system (NMS) that communicates to the telecommunication network via an external DLP node that is controlled by the administrator and that connects to the telecommunication network.
